(19) United States
(12) Patent Application Publication
(10) Pub. No.: US 2012/0184672 A1
(43) Pub. Date: Jul. 19, 2012

(54) POLY (LACTIC-ACID) RESIN COMPOSITIONS

(75) Inventors: DANUT RISCANU, MONTREAL (CA); PIERRE SARAZIN, MONTREAL (CA)

(73) Assignees: TEKNOR APEX COMPANY, PAWTUCKET, RI (US); CERESTECH, INC., MONTREAL (CA)

(21) Appl. No.: 13/349,202

(22) Filed: Jan. 12, 2012

Related U.S. Application Data
(60) Provisional application No. 61/432,761, filed on Jan. 14, 2011.

(51) Int. Cl. C08L 67/04; B29C 47/00; B29C 51/02; B29C 45/00

(52) U.S. Cl. 524/601; 264/328.1; 264/176.1; 264/210.1

(57) ABSTRACT

There is provided a polylactic acid resin composition having elevated impact resistance and/or elevated heat deflection temperature, the composition comprising polylactic acid as a major phase. There is also provided an article made of this composition and a masterbatch for producing this composition through dilution with polylactic acid. Finally, there is also provided a process for making such a composition, the process comprising the step of compounding together the following ingredients: polylactic acid, a mineral filler, a chain mobility additive, optionally an impact modifier, and optionally a chain extender, thereby producing the resin composition.

### CROSS-REFERENCE TO RELATED APPLICATIONS

This application claims benefit, under 35 U.S.C. §119(e), of U.S. provisional application Ser. No. 61/432,761, filed on Jan. 14, 2011. This document is incorporated herein in its entirety by reference.

### FIELD OF THE INVENTION

The present invention relates to a polylactic acid resin composition. More specifically, the present invention is concerned with a polylactic acid resin composition comprising a chain mobility additive and a mineral filler.

### BACKGROUND OF THE INVENTION

Polylactic acid (PLA) is produced from renewable resources such as corn and is compostable. Due to a low glass transition temperature (Tg) in its amorphous form, the thermal stability of PLA is generally not sufficiently high enough to be used as an alternative to many conventional polymer applications.

In industrial processes, such as injection molding, where low cycle time is generally an important requirement, the high cooling rates involved do not allow sufficient time for PLA crystallization to occur. This results in articles with poor heat resistance. Specifically, PLA is softened in the vicinity of its glass transition temperature and accordingly does not acquire sufficient heat resistance.

The literature shows various routes to increase the rate of PLA crystallization as well as resin compositions containing polylactic acid. Reference is made to the list of references provided below.

### SUMMARY OF THE INVENTION

In accordance with the present invention, there is provided:
1. A polylactic acid resin composition comprising polylactic acid as a major phase, a chain mobility additive and a mineral filler.
2. The resin composition of item 1, having elevated impact resistance.
3. The resin composition of item 2, wherein the impact resistance is of at least 30 J/m.
4. The resin composition of item 3, wherein the impact resistance is of at least 40 J/m.
5. The resin composition of item 4, wherein the impact resistance is of at least 50 J/m.
6. The resin composition of any one of items 1 to 5, being non-amorphous.
7. The resin composition of item 6, having elevated heat deflection temperature.
8. The resin composition of item 7, wherein the heat deflection temperature is of at least 65° C. at 0.455 MPa.
9. The resin composition of item 8, wherein the heat deflection temperature is of at least 70° C.
10. The resin composition of any one of items 1 to 9, comprising between about 50% and about 94.5% by weight of polylactic acid, based on the total weight of the composition.
11. The resin composition of any one of items 1 to 10, comprising between about 0.5% and about 45% by weight of the chain mobility additive, based on the total weight of the composition.
12. The resin composition of any one of item 1 to 11, wherein the chain mobility additive is a plasticizer, a lubricant or a combination thereof.
13. The resin composition of item 12, wherein the chain mobility additive is a plasticizer.
14. The resin composition of item 12 or 13, wherein the plasticizer is an ester, an ester of a carboxylic acid, a glyceride ester, an isosorbide diester, a vegetable oil based ester, a vegetable sourced polyol ester, an epoxidized polyol ester, a modified vegetable oil, a modified soybean oil, an epoxidized vegetable oil, a polymeric ester, a fatty acid ester, an adipate, a polyadipate, bis(2-ethylhexyl)adipate, a citrate, acetyl tributyl citrate, an acetylated monoglyceride, a phosphate, a trimellitate, a malate, a polymeric ester, a succinate, a sebacate, an azelate, an oligomer, a polymeric plasticizer, or a combination thereof.
15. The resin composition of item 13 or 14, comprising between about 2% and about 45% by weight of the plasticizer, based on the total weight of the composition.
16. The resin composition of item 12, wherein the chain mobility additive is a lubricant.
17. The resin composition of item 12 or 16, wherein the lubricant is a wax.
18. The resin composition of item 17, wherein the lubricant is ethylene bis-stearamide or ethylene bis-oleamide.
19. The resin composition of any one of items 12, and 16 to 18, comprising between about 0.5% and about 10% by weight of the lubricant, based on the total weight of the composition.
20. The resin composition of any one of items 1 to 19, wherein the mineral filler is a silicate, talc, quartz, mica, kaolin, wollastonite, a montmorillonite, a nanoclay, feldspar, asbestos, silica, a salt, a phosphate, calcium carbonate, calcium sulfate, barium sulfate or a combination thereof.
21. The resin composition of any one of items 1 to 20, comprising between about 5% and about 49.5% by weight of the mineral filler, based on the total weight of the composition.
22. The resin composition of any one of items 1 to 21, further comprising an impact modifier.
23. The resin composition of any one of items 1 to 22, further comprising a chain extender.
24. The resin composition of any one of items 1 to 23, further comprising one or more conventional additive.
25. The resin composition of any one of items 1 to 24, being essentially free of an organic nucleating agent.
26. An article made from the composition of any one of items 1 to 25.
27. The article of item 26, wherein the article is a molded article.
28. The article of item 26, wherein the article is an extruded article.
29. The article of item 26, wherein the article is a thermoformed article.
30. A masterbatch being a concentrated resin composition comprising the same components as the resin composition of any one of items 1 to 25 in the same proportions, except that it comprises less polylactic acid.
31. A process for making a resin composition according to any one of items 1 to 25, the process comprising the step of compounding the following ingredients:
   polylactic acid,
   a mineral filler,
   a chain mobility additive,
   optionally an impact modifier,
   optionally a chain extender, and
   optionally one or more conventional additive, thereby producing the resin composition.
32. The process of item 31, wherein the compounding is carried out in an extruder.
33. The process of item 31 or 32, wherein all the ingredients are compounded simultaneously.
34. The process of item 31 or 32, wherein one or more of the ingredients are first compounded and the remaining ingredients are added downstream.
35. The process of item 34, wherein the polylactic acid, the mineral filler, and if present, the optional impact modifier, the optional chain extender and the optional conventional additive(s) are first compounded and the chain mobility additive is added downstream.
36. The process of any one of items 31 to 35, further comprising the step of molding the composition.
37. The process of item 36, wherein the composition is molded at a mold temperature of about 50° C. to about 110° C.
38. The process of item 37, wherein the composition is molded at a mold temperature of about 80° C. to about 110° C.
39. The process of any one of item 36 to 38, wherein the composition is injection-molded.
40. The process of item 39, wherein the composition is injection molded in a cycle time of 60 seconds or less.
41. The process of item 40, wherein the cycle time is of 35 seconds or less.
42. The process of item 41, wherein the cycle time is of 25 seconds or less.
43. The process of any one of items 31 to 35, further comprising the step of extruding the composition into an extruded article.
44. The process of item 43, wherein the extruded article is a sheet.
45. The process of item 43 or 44, further comprising a step of thermoforming the extruded article into a thermoformed article.

### BRIEF DESCRIPTION OF THE DRAWINGS

In the appended drawings:

FIG. 1 shows HDT and Izod as a function of the percentage of Danisco 2 for a composition comprising PLA 3001D, but not comprising a mineral filler; and

FIG. 2 shows HDT and Izod as a function of the percentage of talc for a composition comprising PLA 3001D, but no chain mobility additive.

### DETAILED DESCRIPTION OF THE INVENTION

Turning now to the invention in more details, there is provided, in a first aspect, a polylactic acid (PLA) composition. The composition comprises PLA as a major phase.

The resin composition of the present invention advantageously has elevated impact resistance, elevated heat deflection properties or both. Herein, elevated impact resistance means an impact resistance higher than that of pure polylactic acid. Similarly, elevated heat deflection means a heat deflection higher than that of pure polylactic acid.

In embodiments, the impact resistance of the resin composition is of at least 30 J/m. In more specific embodiments, this impact resistance is of at least about 40 J/m or is about 50, 80, 100, 150, 200, or 250 J/m or more. In these and other embodiments, the impact resistance may be about 250, 350, 500, 650, or 750 J/m or less.

In embodiments, the heat deflection temperature of the resin composition is of at least 65° C. at a load of 0.455 MPa. In more specific embodiments, this heat deflection temperature is of about 70, 80, 90, 100 or 115° C. or more. In these and other embodiments, the heat deflection temperature may be about 80, 100, 125 or 150° C. or less.

Without being bound by theory, it is believed that the elevated heat deflection temperature is due to some degree of crystallinity in the resin composition. Therefore, it is advisable, when an elevated heat deflection temperature is desired, to expose the composition to conditions leading to its partial crystallization. Depending on the conditions, polylactic acid may crystallize between about 80° C. and about 150° C. A preferred crystallization temperature would be between about 100 and about 150° C. One simple way to induce some crystallization is to bring the composition to this temperature or some higher temperature and allow it to cool slowly. Such conditions are generally met when the composition is thermoformed or molded in a mold. The mold can even be heated to further reduce the cooling rate and allow greater crystallization.

Therefore, in embodiments, the composition is non-amorphous. Herein, non-amorphous means that the composition shows at least some crystallinity. Crystallinity will be evidenced by one or more signals (or peaks) observed, in addition to the well-known amorphous halo, in an X-ray diffraction pattern.

As used herein, the term “major phase” means that the polylactic acid is present at about 50% or more by weight, based on the total weight of the composition. In embodiments, the composition contains from about 50 to about 94.5% by weight of PLA. In more specific embodiments, the PLA is present at about 55%, 60%, 65%, 70%, 75%, 80% or 85% or more by weight, based on the total weight of the composition. In these and other embodiments, PLA is present at about 94.5%, 90%, 85%, 80%, or 75% or less by weight, based on the total weight of the composition.

There are no particular limitations on the molecular weight of the PLA. Generally however, it was found that the higher the molecular weight of PLA, the higher the achieved impact strength without sacrificing the heat resistance of the overall composition. In embodiments, the molecular weight of PLA is between about 10,000 and about 500,000. In embodiments, the molecular weight is about 20,000, 50,000, 100,000, 200,000, 300,000, or 500,000 g/mol or more. There is no particular upper limit for the molecular weight.

In embodiments, the resin composition comprises polylactic acid (PLA) as a major phase, a chain mobility additive and a mineral filler.

In embodiments, the resin is substantially free of a nucleating agent, especially of an organic nucleating agent. Such agents provide nucleating sites and are well-known to the skilled person.

The chain mobility additive may be a lubricant, a plasticizer, or a combination thereof.

The lubricant may be any lubricant known to the skilled person as useful in the compounding of polymeric resins. In particular, the lubricant may be bio-based or non-bio-based, or a combination thereof. In embodiments, the lubricant may be for example a wax, such as a polymeric wax, a vegetable or a synthetic wax. Specific examples of a vegetable wax include ethylene bis-stearamide (EBS) and ethylene bis-oleamide.

The plasticizer may be any plasticizer known to the skilled person as useful in the compounding of polymeric resins. In particular, the plasticizer may be bio-based or non-bio-based, or a combination thereof. In embodiments, the plasticizer may be an ester, an ester of a carboxylic acid, a glyceride ester, an isosorbide diester, a vegetable oil based ester, a vegetable sourced polyol ester, an epoxidized polyol ester, an epoxidized vegetable oil, a polymeric ester, a fatty acid ester, an adipate, a polyadipate, bis(2-ethylhexyl)adipate, a citrate, acetyl tributyl citrate, an acetylated monoglyceride, a phosphate, a trimellitate, a malate, a polymeric ester, a modified vegetable oil, modified soybean oil, a succinate, a sebacate, an azelate, an oligomer, a polymeric plasticizer or a combination thereof. Specific examples of bio-based plasticizers include Danisco™ 1 and Danisco™ 2, supplied by DANISCO Plasticizers. Danisco™ 1 is an acetic acid ester/polyglycerol ester blend and is 85% bio-based. Danisco™ 2 is an acetic acid ester of monoglycerides and is 80% bio-based. Other examples of bio-based plasticizer are epoxydized soybean oil (ESO) (often being 94% bio-based and which generally has the advantage of being inexpensive) or n-octyl n-decyl adipate (NONDA).

In embodiments, the composition comprises from about 0.5 to about 45% by weight of the chain mobility additive based on the total weight of the composition. In particular, when the chain mobility additive is a lubricant, the composition may comprise, in embodiments, about 0.5%, 1%, 2% 3%, 4%, 5%, 6%, 7% or more of the lubricant. In these or other embodiments, the composition may comprise about 10%, 6.5%, 5%, or 3% or less of the lubricant. When the chain mobility additive is a plasticizer, the composition may comprise, in embodiments, about 2%, 5%, 8%, 10%, 15%, 20% or 25% or more of the plasticizer. In these or other embodiments, the composition may comprise about 30%, 25%, 15%, 13%, or 10% or less of the plasticizer.

Using a bio-based chain mobility additive advantageously yields a final resin composition with a high bio-based content.

The mineral filler may be any mineral filler known to the skilled person as useful in the compounding of polymeric resins. Specific examples of mineral fillers include talc, silica, silicates, calcium carbonate, calcium sulfate, mica, wallastonite, kaolin and combinations thereof.

In embodiments, the composition comprises from about 5% to about 49.5% by weight of the mineral filler, based on the total weight of the composition. In embodiments, the composition comprises about 5%, 10%, 15%, 20%, or 30% or more of the mineral filler. In these or other embodiments, the composition comprises about 45%, 35%, 30%, 25%, 20% or 15% or less of the mineral filler.

The composition may optionally further comprise an impact modifier. The impact modifier may be any impact modifier known to the skilled person as useful in the compounding of polymeric resins. Non-limiting examples of which include Biostrength 150, acrylic core-shell Biostrength (Arkema), Metablen (Mitsubishi Rayon), acrylic TPE (Kuraray), ultra high rubber ABS like Blendex (Chemtura), and combinations thereof. It is well within the skills of the skilled person to choose the appropriate amount of impact modifier to be used to obtain a composition with the desired properties. As is shown in the examples below however, compositions having both elevated impact resistance and elevated heat deflection temperature can be obtained without the use of impact modifiers.

The composition may optionally further comprise a chain extender. The chain extender may be any chain extender known to the skilled person as useful in the compounding of polymeric resins. Non-limiting examples of which include Jancryl ADR-4368 and functional silanes. In embodiments, the composition comprises from about 0.1% to about 5% by weight of the chain extender, based on the total weight of the composition. In embodiments, the composition comprises between about 0.1% and about 2% of the chain extender. As is shown in the examples below however, compositions having both elevated impact resistance and elevated heat deflection temperature can be obtained without the use of chain extenders.

Conventional additives as known in the art may also be included in the resin composition. Non-limiting examples include fibers, clays, dispersants, functionalized dispersants, silanes with or without second functionality, polymeric coupling agents and combinations thereof. Other additives are anti-hydrolysis agents, processing aids, flame retardants, colorants, fragrances, UV stabilizers, antimicrobial agents, antioxidants, antistatic agents, mold release agents or combinations thereof. In embodiments, the composition comprises one or more of these additives. In other embodiments, the composition is essentially free of such additives.

If desired, the resin composition may be formulated with virtually only FDA compliant components for targeting the biodegradable disposable goods market. Indeed, these compositions advantageously yield less waste in landfills and are biodegradable. Further, the compositions may be compostable, regardless of whether the chain mobility additive is bio-based or non-bio-based.

The resin compositions of the present invention are useful for many applications such as thin wall applications where high heat resistance and/or good impact strength are desired.

In embodiments, the resin composition is at least 70 wt % bio-based. Compositions with high bio-based content are suitable for replacing oil-derived commodity plastics for semi-durable applications such as cosmetics, electronics and office accessories.

Further, in embodiments, the composition is compostable. As is well known in the art, compostable compositions are biodegradable compositions having a controlled degradation time leaving little toxic residues. Reference is made to for example ASTM D6400.

The variety of formulations and performances shown in the examples below demonstrates that the compositions of the present invention can be tailored according to a wide range of customer requirements. This allows for a broad area of applications where high heat resistance and/or high impact strength are a must. Furthermore, the use of low cost bio-based plasticizers, as for example modified soybean oil, a succinate and the like, may allow for highly optimized cost-performance-high bio-based content articles.

Further, as shown below, the level of impact resistance can be adjusted by several routes: adjusting the level of chain mobility additive and mineral filler, adding a chain extender (which lowers the PLA molecular weight degradation during processing), increasing the molecular weight of PLA, or using mixtures of mineral fillers with various shapes.

In another aspect, the present invention also provides an article made from the above-described composition. The article may be molded, extruded or thermoformed. The molded article is advantageously injection-molded in a short cycle time which may be of about 60 seconds or less. The cycle time may also be of 35 seconds or less or of 25 seconds or less. Such low injection molding cycle times are advantageous in that they increase production and lower overall costs.

In a further aspect of the invention, there is provided a masterbatch of the above resin composition. This masterbatch is a concentrated resin composition intended to be diluted with PLA to produce the above resin composition. As such, the masterbatch comprises the same components as the above resin composition in the same proportions, except that it comprises less PLA.

In a further aspect, the present invention also provides a process for making the above resin composition. In embodiments, the process includes the step of compounding the following ingredients: the PLA, the chain mobility additive, the mineral filler and, if present, the impact modifier, the chain extender and/or the conventional additives.

The chosen sequence of adding these ingredients is flexible, but should allow for high dispersion into the PLA matrix. The exact sequence will depend on the physical and chemical characteristics of the additives. For example, when the PLA, mineral filler and optionally the impact modifier are compounded in an extruder, feeding the chain mobility additive downstream into the extruder allows for a higher dispersion of the various ingredients into the PLA. In another embodiment, all the ingredients are added at once, which allows for the chain mobility additive to further act as a filler dispersant.

The optional conventional additives, if present, can be compounded at the same time as the above ingredients.

In embodiments, the process further comprises the step of molding the composition into a molded article. A highly loaded PLA resin, known as masterbatch, can be used and further diluted to the desired final composition during the molding step. As mentioned above, the resin composition may advantageously be molded in a short cycle time, thus increasing productivity and lowering costs. The mold is kept at a high temperature using any means, for example by circulating hot water. In embodiments, the circulating water temperature may be between about 50 to about 110° C. In more specific embodiments, the circulating water temperature is between 80 to about 110° C. The high mold temperature advantageously lowers the cooling rate of the molded article. As discussed above, and without being bound by theory, it is believed that increasing the crystallization of the PLA maintains a level of material stiffness that allows it to exceed the glass transition temperature of the amorphous phase of the PLA. As such, lowering the cooling rate of the molded article increases crystallization of the PLA, which yields higher heat resistance.

In other embodiments, the process comprises the step of extruding the composition into an extruded article. A highly loaded PLA resin, known as masterbatch, can be used and further diluted to the desired final composition during the extrusion step. The extruded article may be for example a sheet.

The extruded article may be subsequently thermoformed into an article, such as a container. It should be noted that while such an extruded article or sheet can have no or low crystallinity, the crystallinity is desirably developed during the heating of the sheet during thermoforming. This results in the thermoformed article showing high heat resistance.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

PLA resin compositions were produced by extrusion. The resin compositions were further injection molded into articles for heat deflection temperature (HDT) and mechanical properties testing.

PLA 3251D, PLA 3001D and PLA 4032D were supplied by NatureWorks LLC. PLA 3251D is of lower molecular weight than PLA 3001D, which is itself of lower molecular weight than PLA 4032D.

The chain mobility additive was either bio-based (Danisco 1&2 supplied by Danisco™, ESO, NONDA and EBS wax supplied by Teknor Apex™) or non-bio-based (DEHA and ATBC supplied by Teknor Apex™).

The mineral filler was fine and coarse talc, calcium sulfate, calcium carbonate or wollastonite.

Extrusion Mixing

Prior to extrusion, the PLA granules were dried in an air circulating oven for at least 4 hours at 80° C.

The dried PLA granules and mineral filler (and, optionally, impact modifier powder) were fed into the feeding throat of a 40 mm co-rotating twin-screw extruder. The chain mobility additive was usually added downstream using an injection pump. However, for the formulations containing EBS wax, all components were fed into the feeding throat of the extruder. The extruder barrels temperature profile was set to 165-175° C.

The melt composition was finally granulated using a Gala underwater pelletizer.

Injection Molding

After extrusion, the PLA resin compositions were injection molded into dumbbell-shape specimens (163×12.7×3.2 mm³) and rectangular bars (125×12.7×3.2 mm³). The samples were injection molded using a Sumitomo 110 tons machine at 165 to 185° C. and the water mold cooling temperature was kept at 95° C. The molding cycle time was 25 seconds or 35 seconds depending on the formulation (see Tables 1, 2 and 3).

Characterization

Notched Izod impact was measured according to ASTM D256. The thickness of the specimen was 3.2 mm.

Flexural modulus was measured according to ASTM D790.

Heat distortion temperature (HDT) was measured according to ASTM D648 at 0.455 MPa load. The thickness of the specimen was 3.2 mm.

Properties

All the examples presented in Table 1 show the significant improvement of heat deflection temperature and impact properties over the neat PLA. This improvement is possible while at the same time maintaining a high bio-based content.

Examples 1 and 2, which used a lower molecular weight PLA, demonstrated a high HDT and significantly increased impact strength when compared with PLA alone. These compositions are useful for example in thin wall applications where high heat resistance and good impact strength are desired.

Examples 3 to 6 include a higher molecular weight PLA and show a high HDT with even higher impact strength. The cycle time was increased to 35 seconds. The higher molecular weight PLA results in highly balanced high HDT/high impact strength. The performance and the high bio-based content of Examples 3 and 4 make them suitable to replace oil-derived commodity plastics for semi-durable applications such as cosmetics, electronics and office accessories. Example 5 shows combined high heat resistance and high impact strength obtained in the presence of an impact modifier, Biostrength 150. Example 6 shows a PLA composition where the loading of inexpensive talc was increased and the level of the more expensive plasticizer was decreased. This demonstrates the flexibility of the compositions to obtain cost-optimized formulations while still maintaining high heat resistance and good impact strength.

Examples 7 and 8 compare non bio-based and bio-based plasticizers, when the additives ratio and level is identical.

In Examples 9 and 10, a higher level of the bio-based plasticizer imparts excellent impact properties. Further, the combined properties of HDT and impact strength are well above neat PLA.

In all the compositions prepared as shown in Table 1, the PLA represents the major phase. The variety of formulations and performances shown demonstrates that the PLA compositions of the present invention can be tailored according to a wide range of customer requirements.

TABLE 1
Resin compositions and properties of injection molded articles

| | Materials | | | Examples | | | | | | | | | |
|---|---|---|---|---|---|---|---|---|---|---|---|---|---|
| | (w/w %) | Neat PLA | | 1 | 2 | 3 | 4 | 5 | 6 | 7 | 8 | 9 | 10 |
| Resin | PLA 3251D | 100 | — | 78 | 80 | — | — | — | — | — | — | — | — |
| | PLA 3001D | — | 100 | — | — | 78 | 78 | 76 | 70 | 80 | 80 | 78 | 77 |
| Plasticizer | DEHA | — | — | — | — | 12 | — | — | — | 10 | — | — | — |
| | ATBC | — | — | — | — | — | — | 9 | — | — | — | — | — |
| | Danisco 1 | — | — | 12 | — | — | — | — | 11 | — | — | — | 13 |
| | Danisco 2 | — | — | — | 10 | — | 10 | — | — | — | 10 | 12 | — |
| Filler | Talc | — | — | 10 | 10 | 10 | 12 | 15 | 12 | 10 | 10 | 10 | 10 |
| Impact modifier | Biostrength 150 | — | — | — | — | — | — | — | 7 | — | — | — | — |
| Molding | Cycle time | 26 | 26 | 25 | 25 | 35 | 35 | 35 | 35 | 35 | 35 | 35 | 35 |
| Testing | HDT (° C.) 0.455 MPa | 53.9 | 54 | 112 | 121 | 112 | 117 | 100 | 111 | 69 | 133 | 87 | 81 |
| | Izod notched (J/m) | 22 | 25 | 58 | 58.5 | 135 | 92 | 71 | 103 | 148 | 60 | 98 | 124 |
| | Flexural Modulus (MPa) | 3590 | 3568 | 2965 | 2683 | 4111 | 2791 | 2791 | 1939 | 3743 | 3684 | 2805 | 2022 |

DEHA: Bis(2-ethylhexyl) adipate
Danisco ™ 1: PL 1886; Acetic Acid Ester/Polyglycerol Ester Blend, 85% biobased
Danisco ™ 2: Grinsted Soft-N-Safe; Acetic acid ester of monoglygerides, 80% bio-based
ATBC: Acetyl Tributyl Citrate

The data in Table 2 show optimized high impact formulations while maintaining high HDT. An injection molding HIPS grade with balanced impact and HDT values has been chosen for comparison purpose. The variety of formulations and performances shown in Table 2 demonstrates that the PLA compositions of the present invention with high bio-based content can successfully replace a 100% oil-derived material for high impact semi-durable applications.

TABLE 2
High impact compositions while maintaining high HDT

| | Materials | HIPS | Examples | | | | | | |
|---|---|---|---|---|---|---|---|---|---|
| | (w/w %) | 825 | 11 | 12 | 13 | 14 | 15 | 16 | 17 |
| Resin | PLA 3001D | — | 75 | 76.5 | 78 | 73 | 73 | — | — |
| | PLA 4032D | — | — | — | — | — | — | 74.5 | 78 |
| | HIPS 825 | 100 | — | — | — | — | — | — | — |
| Plasticizer | Danisco 2 | — | 12 | 11 | — | 12 | 12 | 11 | 10 |
| | ESO | — | | — | 10 | — | — | — | — |
| Filler | UltraTalc 609 | — | 13 | 12 | 12 | 10 | 10 | 14 | 12 |
| | Calcium | — | — | — | — | 5 | — | — | — |
| | Carbonate | | | | | | | | |
| | Wollastonite | — | — | — | — | — | 5 | — | — |
| Chain | Joncryl ADR- | — | — | 0.5 | — | — | — | 0.5 | — |
| Extender | 4368 | | | | | | | | |
| Molding | Cycle time | — | 35 | 35 | 35 | 35 | 35 | 35 | 35 |
| Testing | HDT (° C.) 0.455 MPa | 93 | 97.2 | 97.8 | 88.7 | 89 | 97 | 88.8 | 101.9 |
| | Izod notched | 140 | 156 | 200 | 182.4 | 256 | 265 | 310.8 | 197.8 |
| | (J/m) | | | | | | | | |
| | Flexural Modulus | 2150 | 2218 | 2381 | 3018 | 2142 | 2000 | 2077 | 2313 |
| | (MPa) | | | | | | | | |

HIPS 825: Aschem, injection molding grade, balanced HDT and impact value. Data from manufacturer.

Table 3 shows formulations optimized for disposable applications. Such applications generally require low process cycle time, FDA compliant components, high heat resistance and high stiffness. Cost is always a concern for industry, and the examples in Table 3 contain low cost mineral filler at high loading and low cost chain mobility additive. The bio-source nature of the chain mobility additives in Examples 19-23 shows the capability of the present invention to produce compositions of very high renewable content. The impact value is maintained within the required range of such application. Very low loading of chain mobility additive is also possible.

TABLE 3
Optimized low cost and/or high bio-based, FDA compliant, compostable
compositions for disposable application

| | Materials | Neat | Examples | | | | | |
|---|---|---|---|---|---|---|---|---|
| | (w/w %) | PLA | 18 | 19 | 20 | 21 | 22 | 23 |
| Resin | PLA 3251D | 100 | 58 | 58 | 78 | 68 | 86 | 84 |
| Plasticizer | DEHA | — | 12 | — | — | — | — | — |
| | ESO | — | — | 12 | — | — | — | — |
| | NONDA | — | — | — | 10 | — | — | — |
| Lubricant | EBS | — | — | — | — | 2 | 1 | 3 |
| Filler | Ultra Talc 609 | — | — | — | — | — | 12 | 12 |
| | Polar Talc | — | — | 30 | 12 | 30 | — | — |
| | Calcium Sulphate | — | 30 | — | — | — | — | — |
| Impact | Blendex 338 | — | — | — | — | — | 1 | 1 |
| Modifier | | | | | | | | |
| Molding | Cycle time | 26 | 25 | 25 | 25 | 25 | 25 | 25 |
| Testing | HDT (° C.) 0.455 MPa | 53.9 | 118 | 105.1 | 125.8 | 129.8 | 125.8 | 129.3 |
| | Izod notched (J/m) | 22 | 41 | 39.4 | 49 | 41 | 53.9 | 56.2 |
| | Flexural Modulus | 3590 | 3825 | 3688 | 4292 | 8067 | — | — |
| | (MPa) | | | | | | | |

Polar talc: coarse talc, low cost, commercially available
Calcium sulphate: low cost, commercially available

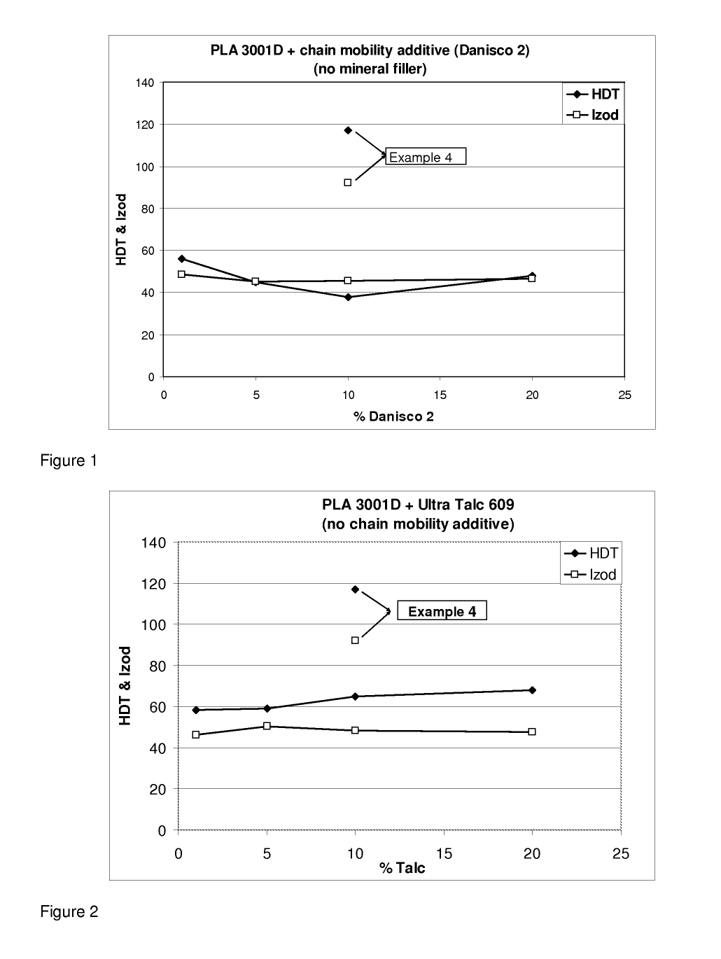

FIGS. 1 and 2 very clearly show the effect of the combination of additives used in the present invention. Compositions that include either plasticizer or mineral filler (1, 5, 10 and 20%) are not able to achieve both elevated impact and elevated heat resistance when processed according with the same procedure described in the present invention. In these Figures, Example 4 (as described in Table 1 above) is a resin composition according to the invention that is shown for comparison purposes.

Sheet Extrusion/Thermoforming

Table 4 shows compositions that have been formulated for sheet extrusion followed by thermoforming into food containers.

The PLA and the additives have been extruded into a 40 mm twin screw extruder and granulated. Further, the obtained granules have been reprocessed into a 35 mm single screw with an 8 inch wide slit die. The take-up rollers have been maintained at a circulating water temperature from 50 to 80° C. The targeted thickness of the sheet was 20 mil.

The sheets has been tested for impact resistance under falling mass (Gardner Impact) according to ASTM D5420. In that regard, Examples 24-27 show highly improved impact values when compared with neat PLA 2003D or PLA 4032D.

Subsequently, the sheet has been cut so that it could fit into the opening of a lab vacuum thermoforming machine. The mold was a male type. The heating cycle time has been calculated in seconds needed for the surface of the sheet to attain a temperature that would allow for a good part definition during forming. It was found that a surface temperature from about 125 to 155° C., which depends on the formulation, was needed to allow for a good part definition and good de-molding.

After forming the sheets into containers, these were filled with water and microwaved. After the water was observed to boil, the test was continued for 5 more minutes. Both neat PLAs showed deformation and water spilled on the microwave's plate before water reached its boiling point. Examples 24-27 showed very good behavior during the test, retaining its original shape.

Further, the stiffness of the walls was checked by hand while the hot water was still inside and the container was removed from the microwave to evaluate the resistance to handling under the load of the non-evaporated hot water. All formulations passed this test without visual deformation.

TABLE 4
Resin compositions and properties of the extruded sheet and thermoformed
containers

| | Materials | | | Examples | | | |
|---|---|---|---|---|---|---|---|
| | (w/w %) | Neat PLA | | 24 | 25 | 26 | 27 |
| Resin | PLA 4032D | 100 | — | 88 | 86 | 89.5 | 70 |
| | PLA 2003D | — | 100 | — | — | — | — |
| Plasticizer | ESO | — | — | — | — | — | 6.5 |
| Lubricant | EBS | — | — | 2 | 2 | 2 | — |
| Filler | Ultra Talc 609 | — | — | 10 | 10 | 8 | — |
| | Polar talc | — | — | — | — | — | 23 |
| Chain extender | Joncryl ADR-4368 | — | — | — | 1 | 0.5 | 0.5 |
| Impact modifier | Metablen S2001 | — | — | — | 1 | — | — |
| Testing - sheet | Gardner Impact | 0.43 | 0.34 | 2.11 | 3.08 | 2.03 | 0.64 |
| 20 mil thickness | Mean failure energy | | | | | | |
| | (J) | | | | | | |
| Testing - formed | 5 min boiling water | failed | failed | passed | passed | passed | passed |
| container | in microwave | | | | | | |

PLA 2003D: thermoforming grade from NatureWorks
PLA 4032: extrusion grade from NatureWorks
Gardner impact: Tested according with ASTM D5420, Geometry GE.
Metablen S2001: Mitsubishi Rayon, impact modifier

Although the present invention has been described hereinabove by way of specific embodiments thereof, it can be modified throughout the whole scope defined in the appended claims.

### REFERENCES

The present description refers to a number of documents, the content of which is herein incorporated by reference in their entirety:
Yu L., Deana K., Li L. (2006) Progress in Polymer Science 31, 576-602;
Li H., Huneault M. A. (2007) Polymer 48, 6855-6866;
Serizawa S., Inoue K., Iji M. (2005) Journal of Applied Polymer Science, Vol. 100, 618-624;
Randall J., Innovation Takes Root Conference, Apr. 15, 2010;
Miyamoto et al., US 2008/108742-A1;
Suzuki et al., U.S. Pat. No. 5,691,424;
Ouchi et al., U.S. Pat. No. 7,084,192;
Mori et al., WO 2010/047370-A1;
Endo et al., US 2010/0093888;
Chung et al., US 2010/0125112;
Serizawa et al., U.S. Pat. No. 7,445,835;
Serizawa et al., US 2009/0054559;
Serizawa et al., US 20090069463
Tanaka et al., US 2009/0137748;
Jung, US 20080145656;
Mochizuki et al., US 2006/0276582;
Ido, US200/80071038;
Chou et al., US 2007/0259195;
Bopp et al., U.S. Pat. No. 7,670,545;
Chung et al., US2009/0306287; and
Lee et al., US20100160559

1. A polylactic acid resin composition comprising polylactic acid as a major phase, a chain mobility additive and a mineral filler.

2. The resin composition of claim 1 having elevated impact resistance.

3. The resin composition of claim 1, being non-amorphous.

4. The resin composition of claim 3, having elevated heat deflection temperature.

5. The resin composition of claim 2, being non-amorphous.

6. The resin composition of claim 5, having elevated heat deflection temperature.

7. The resin composition of claim 1, comprising between about 50% and about 94.5% by weight of the polylactic acid, based on the total weight of the composition.

8. The resin composition of claim 1, comprising between about 0.5% and about 45% by weight of the chain mobility additive, based on the total weight of the composition.

9. The resin composition of claim 1, wherein the chain mobility additive is a plasticizer, a lubricant or a combination thereof.

10. The resin composition of claim 9, comprising between about 0.5% and about 10% by weight of the lubricant, based on the total weight of the composition.

11. The resin composition of claim 9, comprising between about 2% and about 45% by weight of the plasticizer, based on the total weight of the composition.

12. The resin composition of claim 1, the composition comprising about 5% to about 49.5% by weight of the mineral filler, based on the total weight of the composition.

13. The resin composition of claim 1, being essentially free of an organic nucleating agent.

14. The resin composition of claim 1, further comprising an impact modifier and/or a chain extender.

15. A masterbatch being a concentrated resin composition comprising the same components as the resin composition of claim 1, in the same proportions, except that it comprises less polylactic acid.

16. A process for making a resin composition according to claim 1, the process comprising the step of compounding the following ingredients:
polylactic acid,
a mineral filler,
a chain mobility additive,
optionally an impact modifier,
optionally a chain extender, and
optionally one or more conventional additive,
thereby producing the resin composition.

17. The process of claim 16, wherein all the ingredients are compounded simultaneously.

18. The process of claim 16, wherein one or more of the ingredients are first compounded and the remaining ingredients are added downstream.

19. The process of claim 16, further comprising the step of molding the composition.

20. The process of claim 19, wherein the composition is injection-molded.

21. The process of claim 16, further comprising the step of extruding the composition into an extruded article.

22. The process of claim 21, further comprising a step of thermoforming the extruded article into a thermoformed article.
